(19) United States
(12) Patent Application Publication
(10) Pub. No.: US 2025/0343036 A1
(43) Pub. Date: Nov. 6, 2025

(54) VERTICAL DOUBLE-PULSE LASER ABLATION CELL AND USE METHOD THEREOF

(71) Applicant: China University of Geosciences (Wuhan), Wuhan City (CN)

(72) Inventors: Haihong CHEN, Wuhan City (CN); Lifei CHEN, Wuhan City (CN); Yongsheng LIU, Wuhan City (CN); Tao LV, Wuhan City (CN); Jie LIN, Wuhan City (CN); Wen ZHANG, Wuhan City (CN); Wengui LIU, Wuhan City (CN)

(21) Appl. No.: 18/826,328

(22) Filed: Sep. 6, 2024

(30) Foreign Application Priority Data
May 6, 2024 (CN) 202410553652.1

(51) Int. Cl. H01J 49/16; H01J 49/10

(52) U.S. Cl. CPC H01J 49/164; H01J 49/105

(57) ABSTRACT

Provided is a vertical double-pulse laser ablation cell and a use method thereof. A femtosecond laser window is formed in an upper end face of the main housing. The main housing is internally provided an infrared laser channel and a CCD image acquisition channel, which pass through a sample chamber, and a reaction gas channel, a carrier gas channel and a sample gas outlet channel, which communicate with the sample chamber. A spectral interface communicating with the sample chamber is obliquely formed in an upper end of an outer wall of the main housing. Both ends of the infrared laser channel, both ends of the CCD image acquisition channel, one end of the reaction gas channel, one end of the carrier gas channel, one end of the sample gas outlet channel and one end of the spectral interface are located on different outer walls of the main housing.

### CROSS-REFERENCE TO RELATED APPLICATION

This patent application claims the benefit and priority of Chinese Patent Application No. 202410553652.1 filed with the China National Intellectual Property Administration on May 6, 2024, the disclosure of which is incorporated by reference herein in its entirety as part of the present application.

### TECHNICAL FIELD

The present disclosure relates to the technical field of laser ablation analysis, in particular to a vertical double-pulse laser ablation cell, and a use method thereof.

### BACKGROUND

Laser ablation multi-collector inductively coupled plasma mass spectrometry (LA-MC-ICP-MS), which combines laser ablation injection technology and mass spectrometry analysis technology, has gradually become a powerful tool for micro-area in-situ element and isotope analysis of solid samples due to its advantages of small sample consumption, fast testing speed, weak matrix effect, wide range of sample analysis, high spatial resolution and high accuracy and precision. Theoretically, LA-MC-ICP-MS can also be used to accurately analyze high-precision in-situ oxygen isotopes in solid geological samples in micro areas. However, geological samples are complex in composition, and there are a lot of other elements besides oxygen. Various oxides with different binding energies are formed in laser ablation and ICP, and the different oxides have different transmission efficiency in the transmission pipeline, which causes the fractionation of oxygen isotopes and restricts the accurate determination of oxygen isotope composition. In addition, oxides formed by the oxygen and other elements will seriously interfere with the accurate determination of the content and isotope ratio of other elements. Therefore, oxygen and other metal elements in the sample can be separated by inducing redox reaction during laser ablation to eliminate the above problems in mass spectrometry.

However, in the actual high-precision element and isotope analysis and test, various problems need to be overcome to get accurate oxygen content and isotope ratio. It is well known that oxygen is everywhere, such as water vapor and impurities adsorbed on the wall of a sample transmission tube and the inner wall of an ablation cell, which will react with the reaction gas to increase the analysis background. All the parts that can come into contact with the reaction gas, such as the sample ablation cell and the lens, react with the extremely active reaction gas, resulting in the data distortion of the tested sample. The system parameters such as laser energy, laser beam spot and pulse frequency of the laser ablation system also affect the reaction efficiency of the ablated sample aerosol (uneven aerosol particle size, particle agglomeration caused by thermal effect of laser ablation) and the reaction gas, resulting in inaccurate data.

In view of this, a problem that those skilled in the art need to be solved urgently is to design a clean laser ablation cell capable of satisfying various experimental conditions. The ablation cell can be used to debug and optimize various parameter of an instrument, such that the ablated oxide sample aerosol can fully react with the reaction in the ablation cell, and the generated oxygen or aerosol can be sent to mass spectrometry for detection.

### SUMMARY

An objective of the present disclosure is to provide a vertical double-pulse laser ablation cell and a use method thereof to solve the problems in the prior art. Various experimental conditions can be satisfied, such that the ablated oxide sample aerosol can fully react with a reaction gas in the ablation cell. Moreover, the generated oxygen or aerosol can be transported to a plasma mass spectrometry for detection to obtain more real and accurate high-precision element content and isotope ratio data of the sample.

To achieve the objective above, the present disclosure employs the following technical solution:

The present disclosure provides a vertical double-pulse laser ablation cell, including a main housing. A sample chamber is provided in the main housing, a femtosecond laser window is formed in an upper end face of the main housing, an infrared laser channel and a CCD (Charged Coupled Device) image acquisition channel which pass through the sample chamber and are intersected with each other are provided in the main housing, and both ends of the infrared laser channel and both ends of the CCD image acquisition channel extend to outer walls of the main housing and are mounted with laser lenses; a reaction gas channel and a carrier gas channel are symmetrically arranged in the main housing and both communicate with the sample chamber, and one end of the reaction gas channel and one end of the carrier gas channel both extend to outer walls of the main housing; a sample gas outlet channel communicating with the sample chamber is further provided in the main housing, and one end of the sample gas outlet channel extends to an outer wall of the main housing; a spectral interface communicating with the sample chamber is obliquely formed in an upper end of an outer wall of the main housing; and the both ends of the infrared laser channel, the both ends of the CCD image acquisition channel, the one end of the reaction gas channel, the one end of the carrier gas channel, the one end of the sample gas outlet channel and one end of the spectral interface are located on different outer walls of the main housing, respectively.

In some embodiments, the main housing is octagonal-prism-shaped, each of the both ends of the infrared laser channel is provided with an infrared laser window, and two infrared laser windows are formed in two opposite sidewalls of the main housing, respectively; each of the both ends of the CCD image acquisition channel is provided with a CCD image acquisition window, and two CCD image acquisition windows are formed in two opposite sidewalls of the main housing, respectively; the one end of the reaction gas channel is provided with a reaction gas interface, the one end of the carrier gas channel is provided with a carrier gas interface, and the reaction gas interface and the carrier gas interface are located on two opposite sidewalls of the main housing, respectively; and the one end of the sample gas outlet channel is provided with a sample gas outlet interface, and the sample gas outlet interface and the spectral interface are located on two opposite sidewalls of the main housing, respectively.

In some embodiments, each of the femtosecond laser window, the infrared laser windows and the CCD image acquisition windows is internally provided with a lens retaining ring threadedly connected thereto; an upper fixing groove and an upper sealing groove are formed at a position of the femtosecond laser window close to the sample chamber, the laser lens is placed in the upper fixing groove, and the upper sealing groove is formed in one end of the upper fixing groove close to the sample chamber; the upper sealing groove is arranged along a circumference of the sample chamber, and an annular sealing ring is mounted in the upper sealing groove; a side fixing groove and a side sealing groove are formed in each of a position in the infrared laser window close to the sample chamber and a position in the CCD image acquisition window close to the sample chamber; the laser lens is placed in each side fixing groove, and each side sealing groove is formed in one end of the corresponding side fixing groove close to the sample chamber; each side sealing groove is arranged along a circumference of the sample chamber, and an annular sealing ring is mounted in each side sealing groove; an annular sealing ring is also mounted at a lower end of each lens retaining ring, and the laser lens is tightly clamped by annular sealing rings on both sides and the lens retaining ring.

In some embodiments, a through hole is formed in the middle of the lens retaining ring, one end of the through hole away from the sample chamber is chamfered to form a bell mouth, and an inner diameter of the bell mouth gradually increases in a direction from close to the sample chamber to away from the sample chamber.

In some embodiments, the lens retaining ring is made of a nickel metallic rod, and the size of a chamfer at an upper end of the through hole is C2; each annular sealing ring is made of a perfluoroether material; and the laser lens is made of a barium fluoride material and is coated with a laser anti-reflection film.

In some embodiments, the sample gas outlet channel is located above the reaction gas channel and the carrier gas channel, the gas outlet interface is connected to a stainless steel tube by a ferrule joint, and the stainless steel tube is able to extend to a mass spectrometer; each of the reaction gas interface and the carrier gas interface is connected to a stainless steel tube by a ferrule joint, and the stainless steel tube connecting to the reaction gas interface and the stainless steel tube connecting to the carrier gas interface are able to extend to an external gas processing equipment.

In some embodiments, inner walls and the outer walls of the main housing are passivated, and the main housing is made of nickel metal; and an inner surface of each of the infrared laser channel, the CCD image acquisition channel, the reaction gas channel, the carrier gas channel and the sample gas outlet channel has an roughness of Ra3.2.

In some embodiments, two sealing ring grooves are arranged in the spectral interface; and an interface sealing ring is mounted in each sealing ring groove, and is used for sealing and fixing an outer periphery of a spectral probe when the spectral probe extends into the spectral interface.

In some embodiments, multiple threaded holes are formed in a lower end of the main housing, and the main housing is fixed to a laser mobile platform by inserting bolts through the laser moving mobile platform and the threaded holes.

The present disclosure further provides a use method for the vertical double-pulse laser ablation cell above, including the following steps:

S1: cleaning the vertical double-pulse laser ablation cell and a pipeline, reducing total content of oxygen, water, carbon monoxide and carbon dioxide to less than 1 ppb by using a helium purification device mounted at an outlet of a helium gas cylinder; winding each stainless steel tube and the vertical double-pulse ablation cell with heated silica gel tapes; setting a heating temperature to 90° C., and setting flow rate of helium in the stainless steel tube to 50 ml/min, so as to remove impurities left in the stainless steel tube and residual water vapor after contacting with air; after heating, setting flow rate of a helium carrier gas to 5 ml/min, connecting a reaction gas interface to a bromine pentafluoride gas cylinder, and setting flow rate of a reaction gas to 2 ml/min; enabling all gases to pass through a surface of a sample in the sample chamber and each channel in the main housing and then to be discharged from a sample gas outlet interface, thus cleaning each stainless steel tube and each channel in the main housing; and closing a gas flow controller to keep an inside of the main housing and each stainless steel tube sealed;

S2: after the cleaning, setting parameters of an ultraviolet femtosecond laser instrument and an infrared laser instrument, selecting ultraviolet femtosecond laser with a wavelength of 253 nm, and setting a laser frequency of the ultraviolet femtosecond laser to 20 Hz, a laser beam spot of the ultraviolet femtosecond laser to 150 μm, and laser energy of the ultraviolet femtosecond laser to 3 J/cm²; setting a laser frequency of infrared laser to 200 Hz, and a laser beam spot of the infrared laser to 8 mm; and setting the flow rate of the helium with purity of 99.999% to 200 ml/min, and flow rate of purified bromine pentafluoride to 1 ml/min-3 ml/min; and

S3: after setting the parameters of the ultraviolet femtosecond laser instrument and the infrared laser instrument, starting the ultraviolet femtosecond laser and the infrared laser at the same time, wherein the ultraviolet femtosecond laser passes through the femtosecond laser window to ablate and sample an oxide sample in the sample chamber, and an ablated aerosol is mixed with the reaction gas of bromine pentafluoride to produce a chemical reaction; and making mixture fully react in the main housing, by ablating and heating the mixture with the infrared laser, and by gradually optimizing the laser energy, the laser beam spot and the pulse frequency of the ultraviolet femtosecond laser and the infrared laser as well as experimental conditions through an elemental spectrogram measured by a spectrometer placed at a spectral interface and an oscilloscope placed at an other side of the spectrometer, and through a morphological image of ablation plume acquired by a CCD photon detector of the CCD image acquisition window; transporting reacted sample gas to be measured to inductively coupled plasma mass spectrometry for analysis to obtain the element content and isotope ratio of the sample.

Compared with the prior art, the present disclosure has the following technical effects:

Through the vertical double-pulse laser ablation cell provided by the present disclosure, a sample chamber for placing a sample is arranged in a main housing, a femtosecond laser window is formed in an upper end face of the main housing, such that femtosecond laser can pass through the femtosecond laser window to ablate and sample the sample in the sample chamber below the femtosecond laser window. A reaction gas channel and a carrier gas channel are symmetrically arranged in the main housing and both communicate with the sample chamber. One end of the reaction gas channel and one end of the carrier gas channel both extend to outer walls of the main housing. A sample gas outlet channel communicating with the sample chamber is also arranged in the main housing, and one end of the sample gas outlet channel extends to an outer wall of the main housing. Sample aerosol ablated by the femtosecond laser is mixed with a reaction gas introduced from the reaction gas channel for chemical reaction. An infrared laser channel and a CCD image acquisition channel which both pass through the sample chamber and are intersected with each other are arranged in the main housing, and both ends of the infrared laser channel and both ends of the CCD image acquisition channel extend to outer walls of the main housing and are mounted with laser lenses, such that a morphological image of an ablation plume can be acquired by a CCD photon detector mounted at an end of the CCD image acquisition channel. Meanwhile, in order to avoid a phenomenon of element fractionation that increases the error of testing data as some large particles in the aerosol cannot fully react with the reaction gas, an infrared laser beam arranged at the end of the infrared laser channel focuses on the mixture in a central cavity of the ablation cell at the same time to ablate and heat the mixture at a high frequency, thus making the mixture fully react. A spectral interface communicating with the sample chamber is obliquely formed in an upper end of an outer wall of the main housing. A spectral probe is mounted at the spectral interface for measuring the elemental spectrogram by a spectrometer. The laser energy, the laser beam spot and the pulse frequency of the ultraviolet femtosecond laser and the infrared laser as well as experimental conditions can be gradually optimized through the elemental spectrogram in cooperation with the morphological image of the ablation plume acquired by the CCD photon detector, such that the ablated oxide sample aerosol fully reacts with the reaction gas in the ablation cell, and the reacted sample gas to be measured is transported to the multi-collector inductively coupled plasma mass spectrometry for analysis, thus obtaining more real and accurate high-precision element content and isotope ratio testing data of the sample. Both ends of the infrared laser channel, both ends of the CCD image acquisition channel, one end of the reaction gas channel, one end of the carrier gas channel, one end of the sample gas outlet channel and one end of the spectral interface are located on different outer walls of the main housing, respectively, making various functions not interfere with each other.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a vertical double-pulse laser ablation cell according to Embodiment 1;

FIG. 2 is a top sectional view of a vertical double-pulse laser ablation cell in FIG. 1;

FIG. 3 is a front sectional view of a vertical double-pulse laser ablation cell in FIG. 1.

In the drawings: 1—main housing; 2—femtosecond laser window; 3—infrared laser window; 4—CCD image acquisition window; 5—spectral interface; 6—carrier gas interface; 7—reaction gas interface; 8—sample gas outlet interface; 9—sample chamber; 10—lens retaining ring; 11—annular sealing ring; 12—laser lens; 13—upper sealing groove; 14—upper fixing groove; 15—side sealing groove; 16—side fixing groove; 17—interface sealing ring; 18—sample gas outlet channel; 19—reaction gas channel; 20—carrier gas channel; 21—infrared laser channel; 22—CCD image acquisition channel.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

An objective of the present disclosure is to provide a vertical double-pulse laser ablation cell and a use method thereof to solve the problems in the prior art. Various experimental conditions can be satisfied, such that the ablated oxide sample aerosol can fully react with a reaction gas in the ablation cell, thus avoiding element fractionation. Moreover, the generated oxygen or aerosol can be sent to a plasma mass spectrometry for detection to obtain more real and accurate high-precision element content and isotope ratio data of the sample.

In order to make the objectives, features and advantages of the present disclosure more clearly, the present disclosure is further described in detail below with reference to the accompanying drawings and specific embodiments.

### Embodiment 1

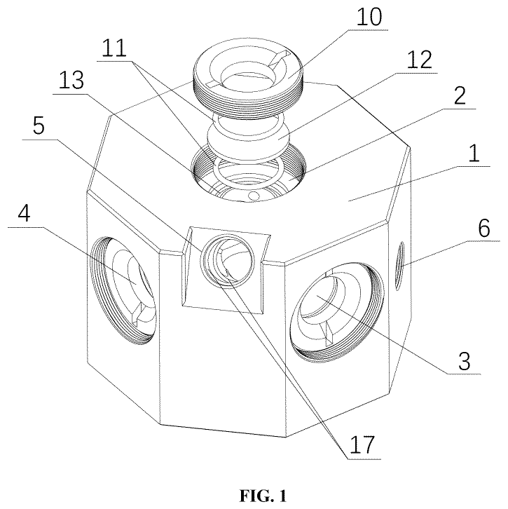

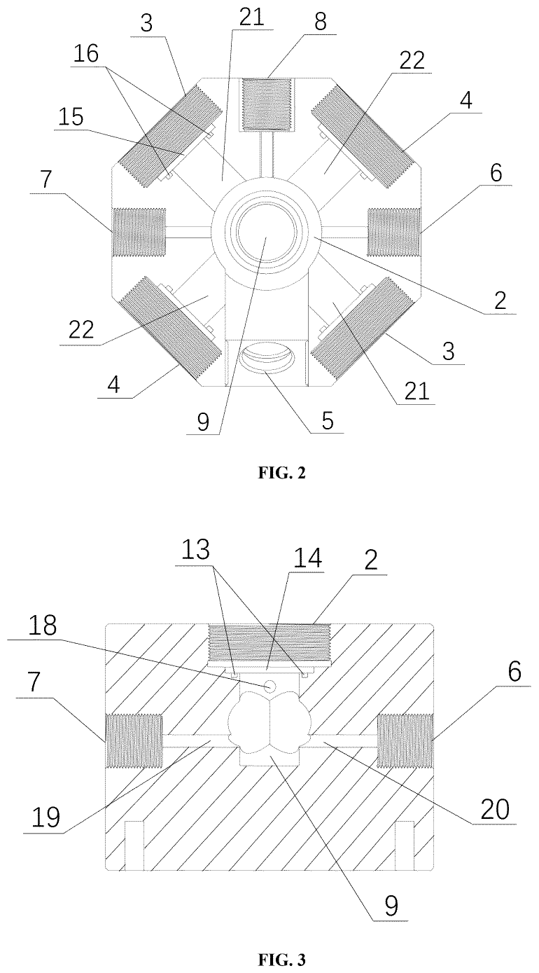

As shown in FIGS. 1 to 3, a vertical double-pulse laser ablation cell provided by this embodiment includes a main housing 1, a sample chamber 9 for placing a sample is provided in a main housing 1, a femtosecond laser window 12 is formed in an upper end face of the main housing 1, femtosecond laser can pass through the femtosecond laser window 2 to ablate and sample the sample in the sample chamber 9 below the femtosecond laser window 2. A reaction gas channel 19 and a carrier gas channel 20 are symmetrically arranged in the main housing 1 and both communicate with the sample chamber 9. One end of the reaction gas channel 19 and one end of the carrier gas channel 20 both extend to outer walls of the main housing 1. A sample gas outlet channel 18 communicating with the sample chamber 9 is also arranged in the main housing 1, and one end of the sample gas outlet channel 18 extends to an outer wall of the main housing 1. Sample aerosol ablated by the femtosecond laser is mixed with a reaction gas introduced from the reaction gas channel 19 for chemical reaction. An infrared laser channel 21 and a CCD image acquisition channel 22, which both pass through the sample chamber 9 and are intersected with each other, are arranged in the main housing 1, and both ends of the infrared laser channel 21 and both ends of the CCD image acquisition channel 22 extend to outer walls of the main housing 1 and are mounted with laser lenses 12, and a morphological image of an ablation plume can be acquired by a CCD photon detector mounted at an end of the CCD image acquisition channel 22. Meanwhile, in order to avoid a phenomenon of element fractionation that increases the error of testing data as some large particles in the aerosol cannot fully react with the reaction gas, an infrared laser beam arranged at the end of the infrared laser channel 21 focuses on the mixture in a central cavity of the ablation cell at the same time to ablate and heat the mixture at a high frequency, thus making the mixture fully react. A spectral interface 5 communicating with the sample chamber 9 is obliquely formed in an upper end of the outer wall of the main housing 1. A spectral probe is mounted at the spectral interface 5 for measuring the elemental spectrogram by a spectrometer. The laser energy, laser beam spot and pulse frequency of the ultraviolet femtosecond laser and the infrared laser as well as experimental conditions can be gradually optimized through the elemental spectrogram in cooperation with the morphological image of the ablation plume acquired by the CCD photon detector, such that the ablated oxide sample aerosol fully reacts with the reaction gas in the ablation cell, and the reacted sample gas to be tested is transported to the multi-collector inductively coupled plasma mass spectrometry for analysis, thus obtaining more real and accurate high-precision element content and isotope ratio testing data of the sample. Both ends of the infrared laser channel 21, both ends of the CCD image acquisition channel 22, one end of the reaction gas channel 19, one end of the carrier gas channel 20, one end of the sample gas outlet channel 18 and one end of the spectral interface 5 are located on different outer walls of the main housing 1, respectively, making various functions not interfere with each other.

In some embodiments, the main housing 1 is octagonal-prism-shaped, each of both ends of the infrared laser channel 21 is provided with an infrared laser window 3, and two infrared laser windows 3 are formed in two opposite sidewalls of the main housing 1, respectively. Each of both ends of the CCD image acquisition channel 22 is provided with a CCD image acquisition window 4, and two CCD image acquisition windows 4 are formed in two opposite sidewalls of the main housing 1, respectively. Moreover, the infrared laser channel 21 and the CCD image acquisition channel 22 are perpendicularly intersected with each other. One end of the reaction gas channel 19 is provided with a reaction gas interface 7, one end of the carrier gas channel 20 is provided with a carrier gas interface 6, and the reaction gas interface 7 and the carrier gas interface 6 are located on two opposite sidewalls of the main housing 1, respectively. One end of the sample gas outlet channel 18 is provided with a sample gas outlet interface 8, and the sample gas outlet interface 8 and the spectral interface 5 are located on two opposite sidewalls of the main housing 1, respectively. The spectral interface 5 is arranged at an inclination of 45°. The carrier gas channel 20 and the reaction gas channel 19 are located on the same straight line, and the sample gas outlet channel 18 is perpendicular to the carrier gas channel 20 and the reaction gas channel 19. Through above design, various outer sidewalls of the main housing 1 are provided with corresponding functional elements, of which various functions do not interfere with each other.

Each of the femtosecond laser window 2, the infrared laser windows 3 and the CCD image acquisition windows 4 is provided therein with a lens retaining ring 10 threadedly connected thereto. Threads in the femtosecond laser window 2, the infrared laser window 3 and the CCD image acquisition window 4 are all M20 fine-pitched internal threads, with a thread pitch of 0.5 mm. A position of the femtosecond laser window 2 close to the sample chamber 1 is provided with an upper fixing groove 14 and an upper sealing groove 13, the laser lens 12 is placed in the upper fixing groove 14, and the upper sealing groove 13 is formed in one end of the upper fixing groove 14 close to the sample chamber 9. The upper sealing groove 13 is arranged along the circumference of the sample chamber 9, and an annular sealing ring 11 is mounted in the upper sealing groove 13. A side fixing groove 16 and a side sealing groove 15 are formed in each of a position in the infrared laser window 3 close to the sample chamber 9 and a position in the CCD image acquisition window 4 close to the sample chamber 9. The laser lens 12 is placed in each side fixing groove 16, and each side sealing groove 15 is formed in one end of the corresponding side fixing groove 16 close to the sample chamber 9. Each side sealing groove 15 is arranged along the circumference of the sample chamber 9, and an annular sealing ring 11 is mounted in each side sealing groove 15. An annular sealing ring 11 is also mounted at a lower end of each lens retaining ring 10. The laser lens 12 is clamped by the annular sealing rings 11 on both sides and the lens retaining ring 10. When the position of each laser lens 12 is fixed, the laser lens 12 can be prevented from being damaging due to large compressing force, and prevented from being shielded.

A through hole is formed in the middle of the lens retaining ring 10. One end of the through hole away from the sample chamber 9 is chamfered to form a bell mouth. An inner diameter of the bell mouth gradually increases in a direction from close to the sample chamber 9 to away from the sample chamber 9, so as to increase an entrance angle of a laser light path and make the laser light path have a larger aspect ratio, thereby reducing the difficulty of laser light path debugging, and facilitating the observation of experimenters.

The lens retaining ring 10 is made of a nickel metallic rod, which has the characteristics of corrosion resistance. The lens retaining ring 10 has a thickness of 5 mm, a depth of a fixing mounting hole between the lens retaining ring 10 and each window is 7 mm, and the size of a chamfer at an upper end of the through hole is C2. The annular sealing ring 11 is made of a perfluoroether material, which does not chemically react with the reaction gas bromine pentafluoride, and has an outer diameter of 13 mm and a wire diameter is 1 mm. The laser lens 12 is made of barium fluoride, and has a diameter of 15 mm and a thickness of 1 mm. The sample chamber 9 has an inner diameter of 11 mm. The laser lens 12 is coated with a laser anti-reflection film. The laser anti-reflection film is an anti-reflection coating AR@253 um, which has a transmittance of more than 99%, and does not react chemically with the reaction gas (bromine pentafluoride).

The spectral probe has a diameter of 8.8 mm, and a length of 40 mm. The spectral interface 5 has an aperture of 9 mm. The sealing ring groove has an outer diameter of 11 mm, a width of 1.5 mm, and a depth of 1 mm. The interface sealing ring 17 is made of perfluoroether, and has an outer diameter of 11 mm, and a wire diameter of 1.5 mm.

The sample gas outlet channel 18 is located above the reaction gas channel 19 and the carrier gas channel 20. A design that the reaction gas interface 7 and the carrier gas interface 6 are located at the bottom and the sample gas outlet interface 8 is located at the top prolongs a travel path of reactants, such that the mixture after the ablated aerosol reacts with the reaction gas can be reheated by the infrared laser until the reaction is fully. The gas outlet interface is connected to a stainless steel tube by a ferrule joint, and the stainless steel tube can extend to a mass spectrometer. Each of the reaction gas interface and the carrier gas interface is connected to a stainless steel tube by a ferrule joint, and the stainless steel tube connecting to the reaction gas interface and the stainless steel tube connecting to the carrier gas interface are able to extend to an external gas processing equipment. The reaction gas interface 7, the carrier gas interface 6 and the sample gas outlet interface 8 are all 1/8NPT (National (American) Pipe Thread Taper), and the 1/8NPT reaction gas interface 7 and the 1/8NPT carrier gas interface 6 at the left and right sides of the main housing 1 are hermetically and fixedly connected to an EP-grade 1/8 stainless steel tube, a gas flow controller, a helium purification device, a helium gas cylinder with a purity of 99.999% and a purified high-purity bromine pentafluoride gas cylinder by 1/8NPT ferrule joints. The 1/8NPT sample outlet interface 8 on the back of the main housing 1 is connected to the 1/8 EP-stage stainless steel tube through a 1/8NPT ferrule joint and extends to the MC-ICP-MS mass spectrometer for fixed sealing.

Both the inner wall and the outer walls of the main housing 1 are passivated, which can effectively prevent the metal from over-corrosion and hydrogen embrittlement, inhibit the generation of acid mist, and make the main housing have better corrosion resistance and not react with the reaction gas, thus effectively solving the problems that high bottoming cost caused by a situation that the sample chamber is easily polluted and corroded, and that the testing results are large in error or the data is in accurate. The main housing 1 is made of high-purity nickel metal. The roughness of an inner surface of each of the infrared laser channel 21, the CCD image acquisition channel 22, the reaction gas channel 19, the carrier gas channel 20 and the sample gas outlet channel 18 is Ra3.2. The surface is smooth and has small pores, and thus is difficult to adsorb impurities and sample particles.

Two sealing ring grooves are arranged in the spectral interface 5, and an interface sealing ring 17 is mounted in each sealing ring groove. The interface sealing ring 17 is used for sealing and fixing the outer periphery of the spectral probe 5 when the spectral probe extends into the spectral interface 5.

A lower end of the main housing 1 is provided with multiple threaded holes. The main housing 1 is fixed to a laser mobile platform by inserting bolts through the laser moving mobile platform and the threaded holes.

### Embodiment 2

This embodiment provides a use method for the vertical double-pulse laser ablation cell above, including the following steps:

S1. A vertical double-pulse laser ablation cell and a pipeline are cleaned, and the total content of oxygen, water, carbon monoxide and carbon dioxide is reduced to less than 1 ppb by using a helium purification device mounted at an outlet of a helium gas cylinder. Each stainless steel tube and the vertical double-pulse ablation cell are wound with heated silica gel tapes. A heating temperature is set to 90° C., and flow rate of helium in the stainless steel tube is set 50 ml/min, so as to remove impurities left in the stainless steel tube and residual water vapor after contacting with air. After heating for eight hours, flow rate of a helium carrier gas is set to 5 ml/min, a reaction gas interface 7 is connected to a bromine pentafluoride gas cylinder, and the flow rate of a reaction gas is set to 2 ml/min. All gases pass through a surface of a sample in a sample chamber 9 and each channel in the main housing 1 and then are discharged from a sample gas outlet interface 8, thus cleaning each stainless steel tube and each channel in the main housing 1 after ventilation for 10 minutes. Afterwards, a gas flow controller is closed to keep the inside of the main housing 1 and each stainless steel tube sealed.

S2. After the cleaning is completed, parameters of an ultraviolet femtosecond laser instrument and an infrared laser instrument are set, ultraviolet femtosecond laser with a wavelength of 253 nm is selected, such that the ultraviolet femtosecond laser has small thermal effect, and is not easy to make the ablated particles aggregate into large particles to cause fractionation of analytical elements. A laser frequency of the ultraviolet femtosecond laser is set to 20 Hz, a laser beam spot of the ultraviolet femtosecond laser is set to 150 μm, and laser energy of the ultraviolet femtosecond laser is set to 3 J/cm². A laser frequency of infrared laser is set to 200 Hz, and a laser beam spot of the infrared laser is set to 8 mm. The flow rate of the helium with purity of 99.999% is set to 200 ml/min, and the flow rate of purified bromine pentafluoride is set to 1 ml/min-3 ml/min.

S3. After the parameters of the ultraviolet femtosecond laser instrument and the infrared laser instrument are set, the ultraviolet femtosecond laser and the infrared laser are started at the same time. The ultraviolet femtosecond laser passes through the femtosecond laser window 2 to ablate and sample an oxide sample in the sample chamber 9, and the ablated aerosol is mixed with the reaction gas bromine pentafluoride to produce a chemical reaction. However, as most large particles in the aerosol do not fully react with the reaction gas, the mixture is by ablated and heated by the infrared laser, and the laser energy, the laser beam spot and the pulse frequency of the ultraviolet femtosecond laser and the infrared laser as well as experimental conditions are gradually optimized through an elemental spectrogram measured by a spectrometer placed at a spectral interface 5 and an oscilloscope placed at an other side of the spectrometer, and through a morphological image of ablation plume acquired by a CCD photon detector of the CCD image acquisition window 4, such that the mixture fully react in the main housing 1. The reacted sample gas to be measured is transported to the multi-collector inductively coupled plasma mass spectrometry for analysis to obtain more real and accurate element content and isotope ratio of the sample.

Specific examples are used herein for illustration of the principles and embodiments of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A vertical double-pulse laser ablation cell, comprising:
a main housing comprising a plurality of outer walls,
a sample chamber provided in the main housing,
a femtosecond laser window formed in an upper end face of the main housing,
an infrared laser channel provided in the main housing and a CCD (Charged Coupled Device) image acquisition channel provided in the main housing, wherein each of the infrared laser channel and the CCD image acquisition channel pass through the sample chamber and are intersected with each other, wherein each of the infrared laser channel and of the CCD image acquisition channel comprise first and second ends which extend to outer walls of the plurality of outer walls of the main housing and are mounted with laser lenses,
a reaction gas channel and a carrier gas channel symmetrically arranged in the main housing, wherein each of the reaction gas channel and the carrier gas channel are configured to communicate with the sample chamber, wherein each of the reaction gas channel and the carrier gas channel have one end which extends to at least one of the plurality outer walls of the main housing,
a sample gas outlet channel provided in the main housing and which is configured to communicate with the sample chamber, wherein the sample gas outlet channel has one end which extends to at least one outer wall of the plurality of outer walls of the main housing, and an interface configured to communicate with the sample chamber, wherein the interface is obliquely formed in an upper end of an outer wall of the plurality of outer walls of the main housing; and
wherein
the first and second ends of the infrared laser channel,
the first and second ends of the CCD image acquisition channel,
the one end of the reaction gas channel,
the one end of the carrier gas channel,
the one end of the sample gas outlet channel, and
the one end of the spectral interface
are each located on different outer walls of the plurality of outer walls of the main housing.

2. The vertical double-pulse laser ablation cell according to claim 1, wherein
the main housing is octagonal-prism-shaped, each of the first and second ends of the infrared laser channel is provided with an infrared laser window, and two infrared laser windows are formed in two opposite sidewalls of the main housing, respectively;
each of the first and second ends of the CCD image acquisition channel is provided with a CCD image acquisition window, and two CCD image acquisition windows are formed in two opposite sidewalls of the main housing, respectively;
the one end of the reaction gas channel is provided with a reaction gas interface, the one end of the carrier gas channel is provided with a carrier gas interface, and the reaction gas interface and the carrier gas interface are located on two opposite sidewalls of the main housing, respectively; and
the one end of the sample gas outlet channel is provided with a sample gas outlet interface, and the sample gas outlet interface and the spectral interface are located on two opposite sidewalls of the main housing, respectively.

3. The vertical double-pulse laser ablation cell according to claim 2, wherein
each of the femtosecond laser window, the infrared laser windows and the CCD image acquisition windows is internally provided with a lens retaining ring threadedly connected thereto;
an upper fixing groove and an upper sealing groove are formed at a position of the femtosecond laser window close to the sample chamber, a laser lens of the femtosecond laser window is placed in the upper fixing groove, and the upper sealing groove is formed in one end of the upper fixing groove close to the sample chamber; the upper sealing groove is arranged along a circumference of the sample chamber, and an annular sealing ring is mounted in the upper sealing groove;
a side fixing groove and a side sealing groove are formed in each of a position in the infrared laser window close to the sample chamber and a position in the CCD image acquisition window close to the sample chamber; the laser lenses are placed in respective side fixing grooves, and each side sealing groove is formed in one end of the corresponding side fixing groove close to the sample chamber; each side sealing groove is arranged along a circumference of the sample chamber, and an annular sealing ring is mounted in each side sealing groove; and
an annular sealing ring is also mounted at a lower end of each lens retaining ring, and each laser lens is tightly clamped by annular sealing rings on both sides and the lens retaining ring.

4. The vertical double-pulse laser ablation cell according to claim 3, wherein
a through hole is formed in the middle of the lens retaining ring,
one end of the through hole away from the sample chamber is chamfered to form a bell mouth, and
an inner diameter of the bell mouth gradually increases in a direction from close to the sample chamber to away from the sample chamber.

5. The vertical double-pulse laser ablation cell according to claim 4, wherein
the lens retaining ring is made of a nickel metallic rod, and the size of a chamfer at an upper end of the through hole is C2;
each annular sealing ring is made of a perfluoroether material; and
each laser lens is made of a barium fluoride material and is coated with a laser anti-reflection film.

6. The vertical double-pulse laser ablation cell according to claim 2, wherein
the sample gas outlet channel is located above the reaction gas channel and the carrier gas channel,
the gas outlet interface is connected to a stainless steel tube by a ferrule joint, and
the stainless steel tube is able to extend to a mass spectrometer;
each of the reaction gas interface and the carrier gas interface is connected to a stainless steel tube by a ferrule joint, and the stainless steel tube connecting to the reaction gas interface and the stainless steel tube connecting to the carrier gas interface are able to extend to an external gas processing equipment.

7. The vertical double-pulse laser ablation cell according to claim 1, wherein
inner walls and the outer walls of the main housing are passivated, and the main housing is made of nickel metal; and
an inner surface of each of the infrared laser channel, the CCD image acquisition channel, the reaction gas channel, the carrier gas channel and the sample gas outlet channel has an roughness of Ra3.2.

8. The vertical double-pulse laser ablation cell according to claim 1, wherein two sealing ring grooves are arranged in the spectral interface; and an interface sealing ring is mounted in each sealing ring groove, and is used for sealing and fixing an outer periphery of a spectral probe when the spectral probe extends into the spectral interface.

9. The vertical double-pulse laser ablation cell according to claim 1, wherein a plurality of threaded holes are formed in a lower end of the main housing, and the main housing is fixed to a laser mobile platform by inserting bolts through the laser moving mobile platform and the threaded holes.

10. A method of using the vertical double-pulse laser ablation cell according to claim 1, comprising:
performing a cleaning by
cleaning the vertical double-pulse laser ablation cell and a pipeline to reduce a total content of oxygen, water, carbon monoxide and carbon dioxide to less than 1 ppb by using a helium purification device mounted at an outlet of a helium gas cylinder;
winding each stainless steel tube of a plurality of stainless steel tubes, and the vertical double-pulse ablation cell with heated silica gel tapes;
setting a heating temperature to 90° C., and setting a flow rate of helium in a stainless steel tube of the plurality of stainless steel tubes to 50 ml/min to remove impurities left in the stainless steel tube and residual water vapor after contacting with air;
after heating, setting the flow rate of a helium carrier gas to 5 ml/min;
connecting a reaction gas interface to a bromine pentafluoride gas cylinder, and setting a flow rate of a reaction gas to 2 ml/min;
enabling all gases to pass through a surface of a sample in the sample chamber and each channel in the main housing, and then to be discharged from a sample gas outlet interface, thus cleaning each stainless steel tube and each channel in the main housing; and
closing a gas flow controller to keep an inside of the main housing and each stainless steel tube sealed;
after the cleaning, setting parameters of an ultraviolet femtosecond laser instrument and an infrared laser instrument, by
selecting ultraviolet femtosecond laser with a wavelength of 253 nm, and setting
a laser frequency of the ultraviolet femtosecond laser to 20 Hz,
a laser beam spot of the ultraviolet femtosecond laser to 150 μm, and
laser energy of the ultraviolet femtosecond laser to 3 J/cm²;
a laser frequency of infrared laser to 200 Hz, and
a laser beam spot of the infrared laser to 8 mm;
a flow rate of the helium with purity of 99.999% to 200 ml/min, and
a flow rate of purified bromine pentafluoride to 1 ml/min-3 ml/min; and
after setting the parameters of the ultraviolet femtosecond laser instrument and the infrared laser instrument, starting the ultraviolet femtosecond laser and the infrared laser at the same time, wherein the ultraviolet femtosecond laser passes through the femtosecond laser window to ablate and sample an oxide sample in the sample chamber, and an ablated aerosol is mixed with the reaction gas of bromine pentafluoride to produce a chemical reaction; and
making a mixture of the ablated aerosol and the reaction gas fully react in the main housing, by ablating and heating the mixture with the infrared laser, and by gradually optimizing the laser energy, wherein the laser beam spot and the pulse frequency of the ultraviolet femtosecond laser and the infrared laser as well as experimental conditions through an elemental spectrogram measured by a spectrometer placed at the interface in the vertical double-pulse laser ablation cell and an oscilloscope placed at a different side of the spectrometer, and
through a morphological image of ablation plume acquired by a CCD photon detector of the CCD image acquisition window, transporting reacted sample gas to be measured to inductively coupled plasma mass spectrometry for analysis to obtain an element content and isotope ratio of the sample.

11. The method according to claim 10, wherein
the main housing is octagonal-prism-shaped, each of the first and second ends of the infrared laser channel is provided with an infrared laser window, and two infrared laser windows are formed in two opposite sidewalls of the main housing, respectively;
each of the first and second ends of the CCD image acquisition channel is provided with a CCD image acquisition window, and two CCD image acquisition windows are formed in two opposite sidewalls of the main housing, respectively;
the one end of the reaction gas channel is provided with a reaction gas interface, the one end of the carrier gas channel is provided with a carrier gas interface, and the reaction gas interface and the carrier gas interface are located on two opposite sidewalls of the main housing, respectively; and
the one end of the sample gas outlet channel is provided with a sample gas outlet interface, and the sample gas outlet interface and the spectral interface are located on two opposite sidewalls of the main housing, respectively.

12. The method according to claim 11, wherein
each of the femtosecond laser window, the infrared laser windows and the CCD image acquisition windows is internally provided with a lens retaining ring threadedly connected thereto;
an upper fixing groove and an upper sealing groove are formed at a position of the femtosecond laser window close to the sample chamber, a laser lens of the femtosecond laser window is placed in the upper fixing groove, and the upper sealing groove is formed in one end of the upper fixing groove close to the sample chamber; the upper sealing groove is arranged along a circumference of the sample chamber, and an annular sealing ring is mounted in the upper sealing groove;
a side fixing groove and a side sealing groove are formed in each of a position in the infrared laser window close to the sample chamber and a position in the CCD image acquisition window close to the sample chamber; the laser lenses are placed in respective side fixing grooves, and each side sealing groove is formed in one end of the corresponding side fixing groove close to the sample chamber; each side sealing groove is arranged along a circumference of the sample chamber, and an annular sealing ring is mounted in each side sealing groove; and
an annular sealing ring is also mounted at a lower end of each lens retaining ring, and each laser lens is tightly clamped by annular sealing rings on both sides and the lens retaining ring.

13. The method according to claim 12, wherein
a through hole is formed in the middle of the lens retaining ring,
one end of the through hole away from the sample chamber is chamfered to form a bell mouth, and
an inner diameter of the bell mouth gradually increases in a direction from close to the sample chamber to away from the sample chamber.

14. The method according to claim 13, wherein
the lens retaining ring is made of a nickel metallic rod, and the size of a chamfer at an upper end of the through hole is C2;
each annular sealing ring is made of a perfluoroether material; and
each laser lens is made of a barium fluoride material and is coated with a laser anti-reflection film.

15. The method according to claim 11, wherein
the sample gas outlet channel is located above the reaction gas channel and the carrier gas channel,
the gas outlet interface is connected to a stainless steel tube by a ferrule joint, and
the stainless steel tube is able to extend to a mass spectrometer;
each of the reaction gas interface and the carrier gas interface is connected to a stainless steel tube by a ferrule joint, and the stainless steel tube connecting to the reaction gas interface and the stainless steel tube connecting to the carrier gas interface are able to extend to an external gas processing equipment.

16. The method according to claim 10, wherein inner walls and the outer walls of the main housing are passivated, and the main housing is made of nickel metal; and an inner surface of each of the infrared laser channel, the CCD image acquisition channel, the reaction gas channel, the carrier gas channel and the sample gas outlet channel has an roughness of Ra3.2.

17. The method according to claim 10, wherein two sealing ring grooves are arranged in the spectral interface; and an interface sealing ring is mounted in each sealing ring groove, and is used for sealing and fixing an outer periphery of a spectral probe when the spectral probe extends into the spectral interface.

18. The method according to claim 10, wherein a plurality of threaded holes are formed in a lower end of the main housing, and the main housing is fixed to a laser mobile platform by inserting bolts through the laser moving mobile platform and the threaded holes.
